(19) United States
(12) Patent Application Publication
(10) Pub. No.: US 2008/0178219 A1
(43) Pub. Date: Jul. 24, 2008

(54) System and method for providing video content

(75) Inventor: Michael F. Grannan, Austin, TX (US)

Correspondence Address: TOLER LAW GROUP, 8500 BLUFFSTONE COVE, SUITE A201, AUSTIN, TX, 78759, US

(73) Assignee: AT&T Knowledge Ventures, LP, Reno, NV (US)

(21) Appl. No.: 11/656,880

(22) Filed: Jan. 23, 2007

(51) Int. Cl. H04N 5/445

(52) U.S. Cl. 725/41

(57) ABSTRACT

A method of providing video content is disclosed that includes receiving content criteria at a set-top box device. The method also includes receiving at least one selection of a video program at the set-top box device, wherein each video program includes at least one program segment. The method also includes receiving each video program at the set-top box device and determining whether each program segment is a relevant segment based on the content criteria. The method also includes assembling all relevant segments at the set-top box device to produce a custom video presentation.

### FIELD OF THE DISCLOSURE

The present disclosure is generally related to systems and methods of providing video content.

### BACKGROUND

A video content provider may offer an enormous quantity of video content to a subscriber. Video content is typically provided to the subscriber as a complete video program, including one or more video segments. For example, a news program may include multiple segments related to different topics, such as a local news segment, a national news segment, a world news segment, a sports news segment, and a weather segment. The subscriber may only be interested in certain portions of different programs, but the subscriber may not have the time or the ability to scan all of the available programs in order to identify and view portions of interest. Hence, there is a need for an improved system and method of providing video content.

### BRIEF DESCRIPTION OF THE DRAWINGS

FIG. 1 is a block diagram of a particular illustrative embodiment of a system to provide video content;

FIG. 2 is a block diagram of a second particular illustrative embodiment of a system to provide video content;

FIG. 3 is a flow diagram of a particular illustrative embodiment of a method of providing video content;

FIG. 4 is a flow diagram of a second particular illustrative embodiment of a method of providing video content;

FIG. 5 is a flow diagram of a third particular illustrative embodiment of a method of providing video content;

FIG. 6 is a diagram of a first particular illustrative embodiment of a graphical user interface to provide video content;

FIG. 7 is a diagram of a second particular illustrative embodiment of a graphical user interface to provide video content;

FIG. 8 is a diagram of a third particular illustrative embodiment of a graphical user interface to provide video content;

FIG. 9 is a diagram of a fourth particular illustrative embodiment of a graphical user interface to provide video content; and

FIG. 10 is a diagram of an illustrative embodiment of a general computer system.

### DETAILED DESCRIPTION OF THE DRAWINGS

The disclosure is directed to systems and methods of providing video content. In a particular illustrative embodiment, a user may access a graphical user interface of a set-top box device to specify topics of interest, search criteria, particular programs, or any combination thereof. The set-top box device may receive video content from a network and analyze the received video content according to the user inputs to identify and to store selected program segments. The set-top box device may assemble the stored program segments into one or more custom video presentations. Each custom video presentation may include program segments or video clips that address the user-specified topics of interest. The set-top box device may provide the custom video presentation to a display device.

In a particular embodiment, a set-top box is disclosed that includes a processor and a memory device accessible to the processor. The memory device includes instructions executable by the processor to receive data indicating content criteria and to receive data corresponding to one or more selections of video programs, where each video program includes at least one program segment having a soundtrack portion. The memory device also includes instructions executable by the processor to receive and store the program segments. The memory device also includes instructions executable by the processor to determine whether each program segment is a relevant segment based on the content criteria and to assemble all relevant segments to produce a custom video presentation.

In another embodiment, a method of providing video content is disclosed that includes receiving content criteria at a set-top box device. The method also includes receiving at least one selection of a video program at the set-top box device, wherein each video program includes at least one program segment. The method also includes receiving each video program at the set-top box device and determining whether each program segment is a relevant segment based on the content criteria. The method also includes assembling all relevant segments at the set-top box device to produce a custom video presentation.

In another embodiment, a processor-readable medium is disclosed that tangibly embodies processor readable instructions executable by a processor to receive data indicating content criteria and to receive data corresponding to one or more selections of video programs, where each video program includes at least one program segment having a soundtrack portion. Further, the processor readable instructions are executable by the processor to receive and store the program segments and to determine whether each program segment is a relevant segment based on the content criteria. The processor readable instructions are also executable by the processor to assemble all relevant segments to produce a custom video presentation.

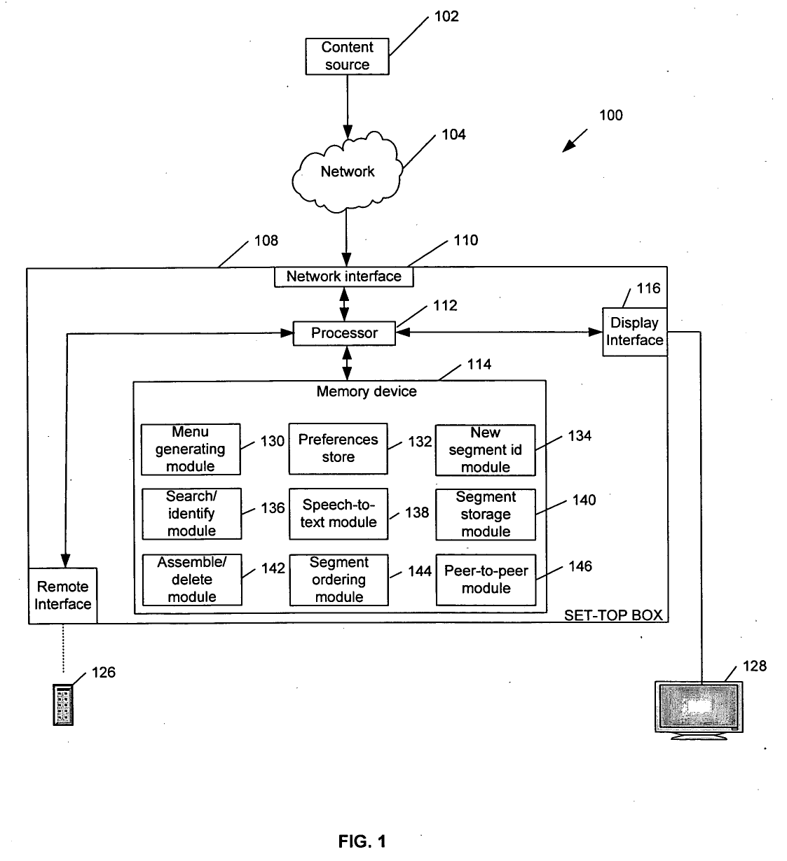

FIG. 1 is a diagram of a particular illustrative embodiment of a system 100 to provide video content. The system 100 includes a content source 102 communicating with a set-top box device 108 via a network. The network 104 may include a private video distribution network, such as a private access network of an Internet Protocol. Television (IPTV) system.

As indicated in FIG. 1, the set-top box device 108 includes a processor 112 and a memory device 114 accessible to the processor 112. The processor 112 can communicate video content to a display device 128 via a display interface 116. In addition, the processor 112 can receive commands from a remote control device 126 via a remote interface 122. In an illustrative, non-limiting embodiment, the processor 112 can communicate with the access network 104 via a network interface 110. In an illustrative embodiment, the set-top box device 108 may communicate with the network 104 via a customer premises equipment (CPE) device (not shown), such as a broadband modem device, a network interface device (NID), other CPE devices, or any combination thereof.

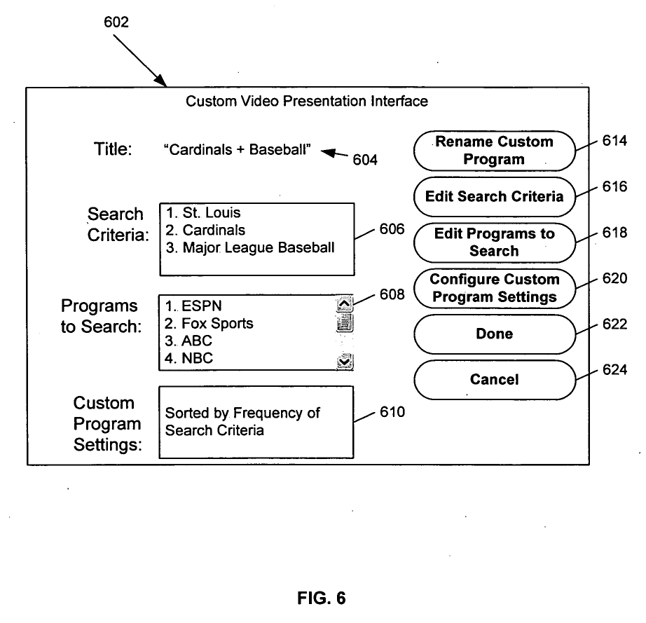

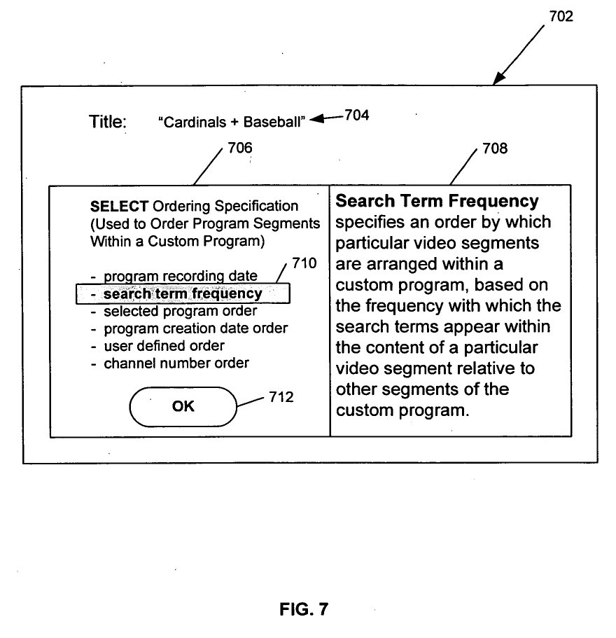

In a particular illustrative embodiment, the set-top box device 108 may receive an input from the remote control device 126 indicating a selection of a command to provide a menu or other graphical user interface (GUI) to configure the set-top box device 108 to produce a custom video presentation. The processor 112 may receive the input from the remote interface 122 and may execute the menu generating module 130 to generate the graphical user interface (GUI) and to send the GUI to the display device 128 via the display interface 116. Examples of such GUIs are illustrated in FIGS. 6-7.

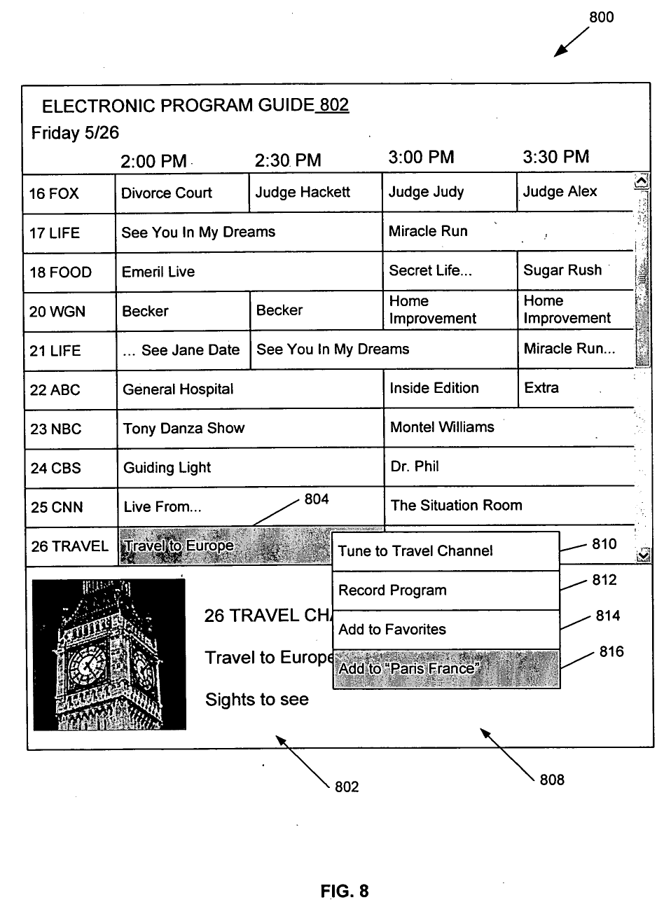

In an illustrative embodiment, the GUI may include user selectable indicators that allow a user to input preferences, such as search terms, programs of interest, topics of interest, custom program ordering specifications, or any combination thereof. In another particular illustrative embodiment, the GUI may include an electronic program guide (EPG) from which the user may select particular programs of interest to be added entirely to a custom video presentation or to be searched for content matching user preferences. An example of such a GUI is illustrated in FIG. 8. The processor 112 may receive data indicating user preferences via the GUI and may store the preferences via the preferences store 132.

In a particular embodiment, the set-top box device 108 may receive content from the content source 102 via the network 104. The received content may include text, audio, video content, other media content, or any combination thereof. In an illustrative embodiment, the content can include one or more segment identifiers that indicate new content segments. If a program is to be added entirely to a custom video presentation, the program can be stored at the memory 114. If a program is to be searched for content matching user preferences, the new segment identification module 134 may be executable by the processor 112 to monitor the received content for new segment identifiers.

In a particular embodiment, the memory device 114 can include a search/identify module 136 that is executable by the processor 112 to scan closed-captioning data associated with an identified content segment and to identify content segments matching user preferences. In an illustrative embodiment, the memory device 114 can include a speech-to-text module 138 to convert audio data associated with the received content into text data, which may be searched using the search/identify module 136 to identify matches to search terms and other user preferences.

In a particular embodiment, the processor 112 may identify a relevant segment of content by determining, for example, that a word or phrase within the closed-captioning data, matches one or more of the user specified search phrases or topics of interest. When received content includes a segment related to the user preferences, such as user-defined topics of interest, the set-top box device 108 may store the relevant segment at the segment storage module 140. In a particular illustrative embodiment, the processor 112 may also store a segment memory starting address and a segment duration of each relevant segment into a relevant segment list, which may be used by the assemble/delete module 140 to assemble a custom video presentation.

In a particular embodiment, the memory device 114 can include an assemble/delete module 142 that is executable by the processor 112 to assemble a custom video presentation from stored video segments, entire stored programs, or any combination thereof, based on user preferences. For example, the assemble/delete module 142 can be executable by the processor 112 to assemble a custom video presentation related to a single user-defined topic of interest from stored video segments. In an illustrative embodiment, the set-top box device 108 can include a selectable listing for the custom video presentation within an electronic program guide. The set-top box device 108 can send the custom video presentation to the display device 128 in response to a selection of the listing.

In a particular embodiment, the memory device 114 can include a segment ordering module 144 that is executable by the processor 112 to order the relevant segments that have been stored prior to concatenation. For example, the user preferences may include an ordering specification that specifies a predefined order in which the relevant segments may be assembled to produce the custom video presentation. In an illustrative embodiment, the ordering specification may specify that relevant segments are to be arranged within the custom video presentation based on a criteria weighting, a program weighting, a program recording date, a user specified order, a relevance of each segment relative to user specified search criteria, a date or time when each segment was broadcast, a frequency of user-defined search terms within each segment, a user-defined weighting of a program in which a relevant segment is found, a user-defined weighting of a content criterion matched by a relevant segment, other specifications, or any combination thereof.

In an illustrative, non-limiting embodiment, the memory device 114 can include a peer-to-peer module 146 that is executable by the processor 112 to share recorded video segments with other set-top box devices 108 via the network 104. In a particular embodiment, the set-top box 108 may communicate a list of stored video segments and associated data to the content source 102. The content source 102 may receive search criteria from another set-top box device and may instruct the set-top box device 108 to transfer selected video segments to the requesting set-top box device. In another embodiment, the set-top box device 108 may operate as a super node to relay data between set-top box devices associated with the network 104. In this embodiment, the peer-to-peer module 146 can be executable by the processor 112 to track content stored at other set-top box devices.

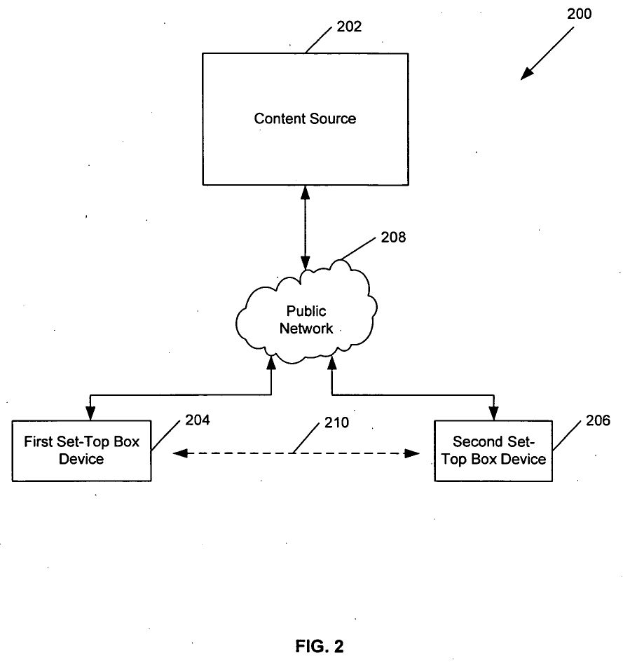

FIG. 2 is a diagram of a second particular illustrative embodiment of a system 200 to provide video content. The system 200 includes a content source 202 communicating with at least a first set-top box device 204 and a second set-top box device 206 via a network 208, such as an Internet Protocol Television (IPTV) access network or a public data network.

In a particular embodiment, the first set-top box device 204 may send search criteria to the content source 202. The first set-top box device 204 may also send a list of user selected programs to the content source 202. The content source 202 may store the search criteria and list of programs and track content stored at the first and second set-top box devices 204 and 206. In an illustrative embodiment, the content source 202 may also transmit search criteria and one or more user selected programs received by the first set-top box device 204, to the second set-top box device 206, for the purposes of performing functions provided by elements of the second set-top box device 206 with respect to specific content programs when sufficient resources are not available at the first set-top box device 204. For example, the second set-top box device 206 can include the new segment identification module 134, search identity module 136, speech-to-text module 138, and segment storage module 140, illustrated in FIG. 1, and the second set-top box device 206 can perform the functions provided by one or more of these modules when sufficient resources are not available at the first set-top box device 204.

In a particular illustrative embodiment, the content source 202 may determine that the second set-top box device 206 has a stored content segment that is related to search criteria received from the first set-top box device 204. In a particular illustrative embodiment, the content source 202 may send a request to the second set-top box device 206 to send the stored content segment to the first set-top box device 204 via the network 208. The first set-top box device 204 may search the content (e.g., closed-captioning data, text data derived from the audio soundtrack, other data, or any combination thereof) associated with the content segment to identify a match with user preferences. If a match is found, the first set-top box device 204 may add the content segment to a custom video presentation. Alternatively, the first set-top box device 204 can send a request to the second set-top box device 206 to perform the segment identification steps (or other steps provided, for example, by the modules 134-140, illustrated in FIG. 1) and send only the content segments meeting the search criteria back to the first set-top box device 204.

In a particular embodiment, the first set-top box device 204 may have available memory and bandwidth to operate as a super node within a peer-to-peer network. In this embodiment, the first set-top box device 204 may track content stored by a group of set-top box devices communicating via the network 208. The first set-top box device 204 may receive search criteria either from the second set-top box device 206 or from the content source 202 and search content segments stored in its memory to identify a match with the search criteria. The first set-top box device 204 may also transmit the search criteria to the other set-top box devices, which may perform similar searches to identify a match. In a particular embodiment, a match may be recognized when one or more terms of the search criteria matches a word or phrase of the closed-captioning data related to a content segment.

When a match is established, the first set-top box device 204 or one of the other set-top box devices may identify a particular content segment as a relevant segment. If the first set-top box device 204 stores the relevant segment stored locally, the first set-top box device 204 may transmit the relevant segment to the second set-top box device 206 via the network 208. The first set-top box device 204 may also send associated data to the requesting set-top box device, such as a video program airing date and a video program generation date related to the relevant segment. If the relevant segment is stored at another set-top box device (not shown), the first set-top box device 204 may transmit a command or a request to the other set-top box device to transmit the relevant segment to the second set-top box device 206.

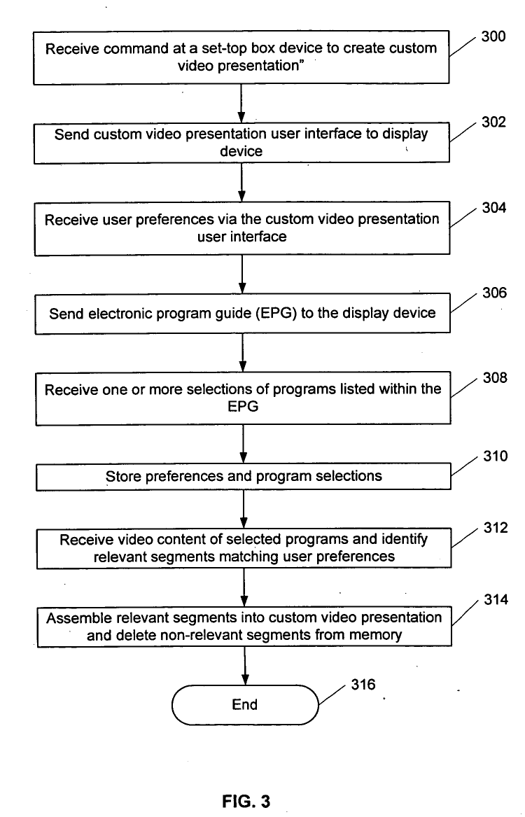

FIG. 3 is a flow diagram of a particular illustrative embodiment of a method of providing video content. At 300, the set-top box device receives a command to create a custom video presentation. Moving to 302, in an illustrative embodiment, the set-top box device can send a user interface that is related to the creation of a custom video presentation to a display device coupled to the set-top box device. Advancing to 304, the set-top box device receives user preferences related to the creation of a custom video presentation via the user interface, such as a title for the custom video presentation, search terms to identify relevant content segments, topics of interest to identify relevant content segments, ordering preferences, or any combination thereof.

Proceeding to 306, in an illustrative embodiment, the set-top box device can send an electronic program guide (EPG) to the display device. Continuing to 308, the set-top box device receives one or more selections of programs listed within the EPG. For example, the selection(s) may identify one or more programs that are likely to include content related to search terms or topics of interest included in the user preferences. At 310, the set-top box device stores the user preferences and program selections.

Continuing to 312, the set-top box device receives video content of the selected programs and identifies relevant segments that match the user preferences. In an illustrative embodiment, the set-top box device can record the video content via a digital video recording portion of the set-top box device. Proceeding to 314, in an illustrative embodiment, the set-top box device can assemble the relevant segments into a custom video presentation and delete non-relevant segments from memory. The method terminates at 316.

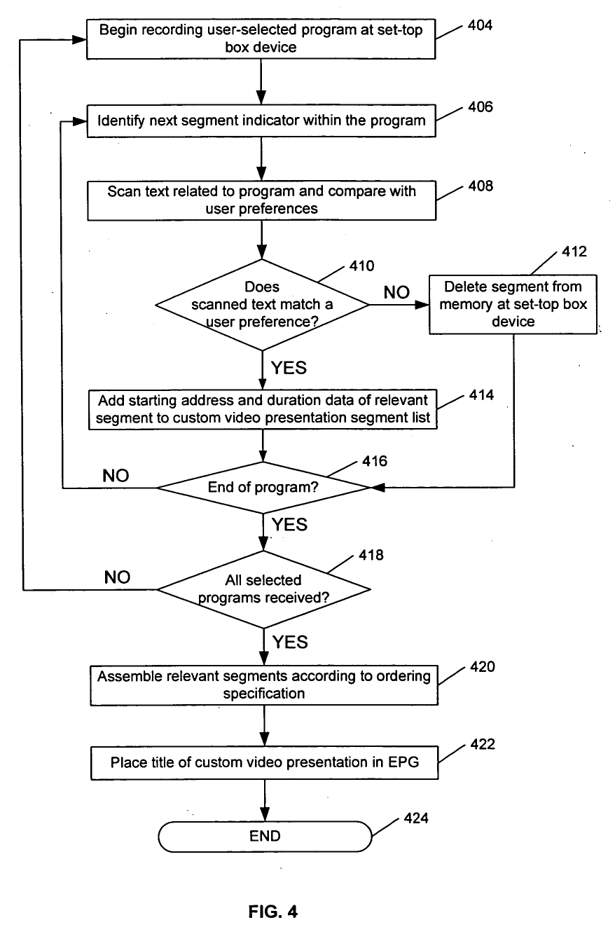

FIG. 4 is a flow diagram of a second particular illustrative embodiment of a method of providing video content. At 404, a set-top box device begins recording a user-selected television program or other video program. Moving to 406, the set-top box device identifies a new segment indicator within the program. For example, the set-top box device can identify topic changes by analyzing closed-captioning or speech recognition-based text, by analyzing textual data sent as a separate Moving Picture Experts Group (MPEG) stream with the video stream, or by analyzing other tags identifying segment changes in a separate MPEG video stream. Proceeding to 408, the set-top box device scans text related to the content segment of the program, such as closed-captioning content or text generated by a speech-to-text converter, to and compares the text to one or more user preferences, such as topics of interest or search terms. Continuing to 410, the set-top box determines whether there is a match between the text related to the content segment and one or more user preferences.

If the set-top box device determines that there is not a match between the text related to the content segment and one or more user preferences, the method moves to 412, and the set-top box device deletes the content segment from memory. On the other hand, if the set-top box device determines that there is a match between the text related to the content segment and one or more user preferences, the method proceeds to 414, and the set-top box device can, in an illustrative embodiment, add a segment starting address and duration data to a segment list associated with a custom video presentation.

Proceeding to 416, the set-top box device determines whether the end of the program has been reached. If the end of the program has not been reached, the method can return to 406, and a next segment indicator can be identified within the program. Conversely, if the end of the program has been reached, the method can advance to 418, and the set-top box device can determine whether all programs selected by the user have been received. If all programs selected by the user have not been received, the method can return to 404, and the set-top box device can begin recording another program. Whereas, if all programs selected by the user have been received at the set-top box device, the method continues to 420, and the set-top box device can assemble the relevant segments into a custom video presentation.

In an illustrative, non-limiting embodiment, the set-top box device can arrange identifications of the relevant segments on the custom video presentation segment list according to an ordering specification received from the user. The set-top box device can generate the custom video presentation by determining a next relevant segment from the list, retrieving the relevant segment from memory based on the starting address and duration data associated with the relevant segment, and adding the relevant segment to the custom video presentation at the end of a prior relevant segment. At 422, in an illustrative embodiment, the set-top box device can add a listing corresponding to the custom video presentation to an electronic program guide (EPG). The method terminates at 424.

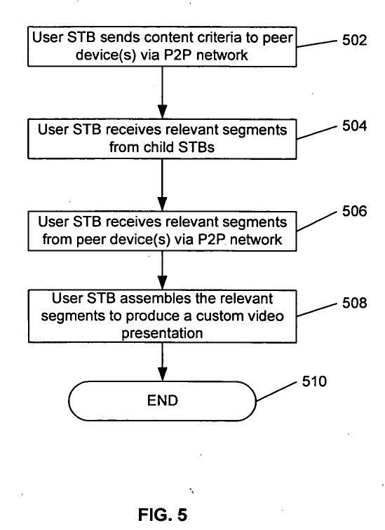

FIG. 5 is a flow diagram of a third particular illustrative embodiment of a method of providing video content. At 502, a user set-top box device sends content criteria to one or more peer devices, such as other set-top box devices, via a network, such as a peer-to-peer (P2P) network. In an illustrative embodiment, the content criteria may include search terms, topics of interest, a list of programs of interest to the user, other content preferences, or any combination thereof. Moving to 504, the user set-top box device receives one or more relevant segments from the peer device(s). In an illustrative, non-limiting embodiment, each peer device can record one or more of the user-selected video programs and can search content (i.e., by analyzing closed-captioning data, text-to-speech data, other data, or any combination thereof) associated with program segments of the recorded program(s) to identify relevant segments.

Continuing to 506, the user set-top box device receives data including relevant segments from the peer device(s) via the network. Proceeding to 508, the user set-top box device assembles the relevant segments to produce a custom video presentation. In a particular embodiment, the custom video presentation may also include content segments recorded at the user set-top box device. The method terminates at 510.

FIG. 6 is a diagram of a particular illustrative embodiment of a graphical user interface 602 to provide video content. The graphical user interface 602 may include an editable title of the custom video presentation 604, a list of search criteria 606, a list of programs to search 608 for relevant content, and one or more custom settings 610, such as ordering settings.

Additionally, the graphical user interface 602 may include a plurality of user selectable indicators 614-624. For example, the graphical user interface 602 may include a “Rename Custom Program” indicator 614, which is selectable by a user to edit the Title 604 of the custom video presentation. In a particular embodiment, the graphical user interface 602 may include an “Edit Search Criteria” indicator 616, which is selectable by a user to add or deleting search terms within the search criteria 606. A user may enter the search terms using the keypad of a remote control device or another input device, such as a personal computer that may be communicatively coupled to the set-top box device.

In a particular embodiment, the graphical user interface 602 may include an “Edit Programs to Search” indicator 618, that is selectable by a user to cause an interactive electronic program guide (EPG) to be displayed for user selection of programs. Alternatively, the user may select the “Edit Programs to Search” indicator 618 to manually add or remove particular programs within the programs to search 608. In a particular embodiment, the graphical user interface 602 may include a “Configure Custom Program Settings” indicator 620 that is selectable by a user to configure the custom program settings 610. In the illustrated embodiment, the custom program settings 610 define an order that is sorted by a frequency of matches of the search criteria.

In a particular embodiment, the graphical user interface 602 may include a “Done” indicator 622 that is selectable by a user to store the custom video presentation preferences. Further, the graphical user interface 602 may include a “Cancel” indicator 624 that is selectable by a user to cancel any changes made to the custom video presentation preferences.

FIG. 7 is a diagram of a second particular illustrative embodiment of a graphical user interface 702 to provide video content. The graphical user interface (GUI) 702 includes a title of the custom video presentation 704, a segment ordering option panel 706 to display a list of available video segment ordering options, and a description panel 708 to provide a brief explanation of a selected ordering option. In the embodiment shown, the “search term frequency” option 710 is highlighted, and the associated description is provided in the description panel 708. The graphical user interface 702 may also include a user selectable indicator, such as an “OK” button 712 to store the ordering specification settings. For example, if the search term frequency option 710 is selected and stored, the set-top box device may arrange relevant program segments within a custom video program based on a frequency with which the search criteria are found within the program segment.

FIG. 8 is a diagram of a third particular illustrative embodiment of a graphical user interface 800 to provide video content. The graphical user interface (GUI) 800 includes an electronic program guide 802 that includes a list of available programs. A particular listing 804 associated with a program entitled “Travel to Europe” is highlighted, which causes the set-top box device to display an associated description in a description panel 806.

In a particular illustrative embodiment, a user may select a key of a remote control device to access a pull down menu 808 of selectable options, including a “Tune to Travel Channel” option 810, a “Record Program” option 812, an “Add to Favorites” option 814, and an “Add to ‘Paris France’” option 816. By selecting the “Record Program” option 812, the user commands the set-top box to record the selected program. By selecting the “Add to Favorites” option 814, the user commands the set-top box device to add the selected listing 804 to a list of favorite programs. A user may add the selected listing 804 to a custom video presentation by selecting the “Add to ‘Paris France’” option 816. If the “Add to ‘Paris France’ option 816 is selected, the set-top box device may record the program and scan the program for relevant segments to be added to a custom video presentation entitled “Paris France.”

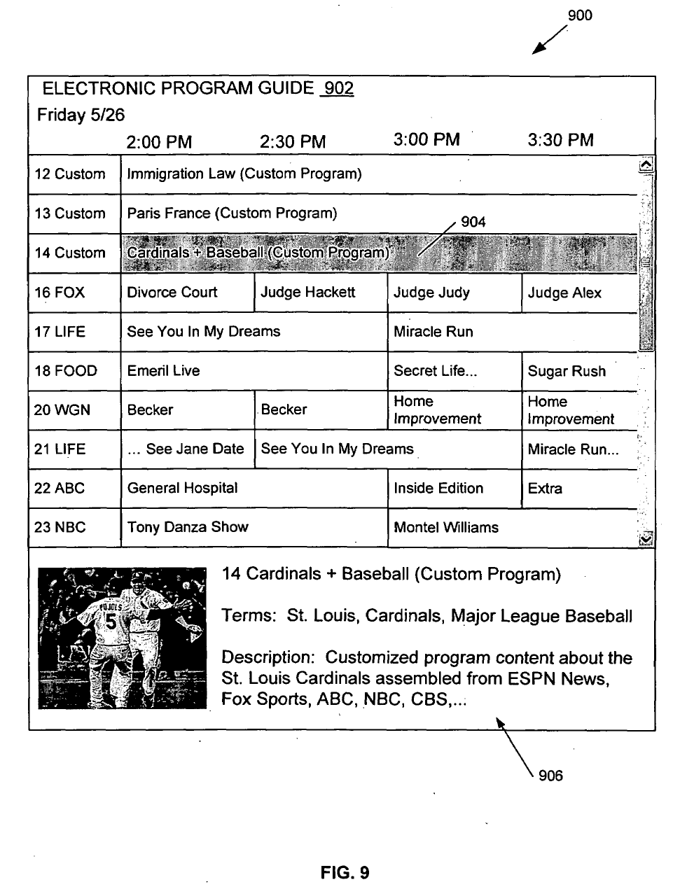

FIG. 9 is a diagram of a fourth particular illustrative embodiment of a graphical user interface 900 to provide video content. The graphical user interface (GUI) 900 includes an electronic program guide (EPG) 902 that includes a list of available programs. The EPG 902 may also include listings associated with one or more custom video presentations, such as the custom listing 904 associated with a custom video presentation entitled “Cardinals+Baseball.” When the custom listing 904 is highlighted, the set-top box device may display a description of the custom video presentations 904 in the description panel 906. In a particular illustrative embodiment, the custom video presentations may be selected in a manner similar to selecting a channel via the electronic program guide. In another particular illustrative embodiment, the custom listing 904 can appear in the recorded programs list of a digital video recording service.

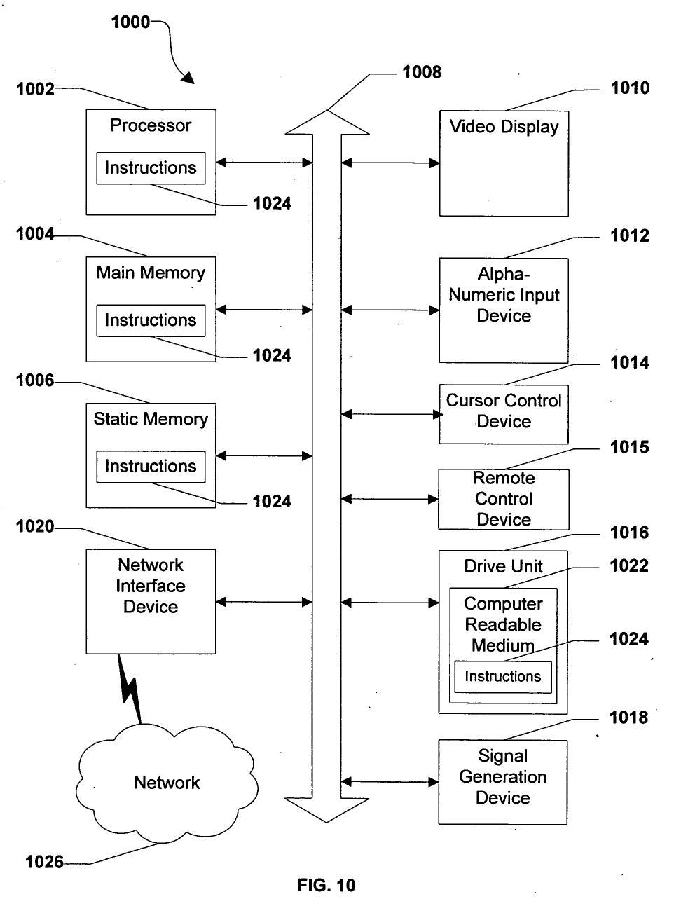

Referring to FIG. 10, an illustrative embodiment of a general computer system is shown and is designated 1000. The computer system 1000 can include a set of instructions that can be executed to cause the computer system 1000 to perform any one or more of the methods or computer based functions disclosed herein. The computer system 1000 may operate as a standalone device or may be connected, e.g., using a network, to other computer systems or peripheral devices, such as the content source and set-top box devices illustrated in FIGS. 1-2.

In a networked deployment, the computer system may operate in the capacity of a content source or set-top box device in a server-client user network environment, or as a peer computer system in a peer-to-peer (or distributed) network environment. The computer system 1000 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 1000 can be implemented using electronic devices that provide voice, video or data communication. Further, while a single computer system 1000 is illustrated, the term “system” shall also be taken to include any collection of systems or sub-systems that individually or jointly execute a set, or multiple sets, of instructions to perform one or more computer functions.

As illustrated in FIG. 10, the computer system 1000 may include a processor 1002, e.g., a central processing unit (CPU), a graphics processing unit (GPU), or both. Moreover, the computer system 1000 can include a main memory 1004 and a static memory 1006, which can communicate with each other via a bus 1008. As shown, the computer system 1000 may further include a video display unit 1010, such as a liquid crystal display (LCD), an organic light emitting diode (OLED), a flat panel display, a solid state display, or a cathode ray tube (CRT). Additionally, the computer system 1000 may include an input device 1012, such as a keyboard, and a cursor control device 1014, such as a mouse. The computer system 1000 can also include a disk drive unit 1016, a signal generation device 1018, such as a speaker or remote control, and a network interface device 1020.

In a particular embodiment, as depicted in FIG. 10, the disk drive unit 1016 may include a computer-readable medium 1022 in which one or more sets of instructions 1024, e.g. software, can be embedded. Further, the instructions 1024 may embody one or more of the methods or logic as described herein. In a particular embodiment, the instructions 1024 may reside completely, or at least partially, within the main memory 1004, the static memory 1006, and/or within the processor 1002 during execution by the computer system 1000. The main memory 1004 and the processor 1002 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 1024 or receives and executes instructions 1024 responsive to a propagated signal, so that a device connected to a network 1026 can communicate voice, video or data over the network 1026. Further, the instructions 1024 may be transmitted or received over the network 1026 via the network interface device 1020.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the disclosed embodiments are not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directedto less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method of providing video content, the method comprising:
receiving content criteria at a set-top box device;
receiving at least one selection of a video program at the set-top box device, wherein each video program includes at least one program segment;
receiving each video program at the set-top box device;
determining whether each program segment is a relevant segment based on the content criteria; and
assembling all relevant segments at the set-top box device to produce a custom video presentation.

2. The method of claim 1, wherein each program segment includes a soundtrack segment and wherein text associated with each soundtrack segment is compared with the content criteria to determine whether the program segment is a relevant segment.

3. The method of claim 2, wherein the content criteria includes at least one search term, at least one topic of interest, at least one program of interest, or any combination thereof.

4. The method of claim 2, wherein the text includes closed-captioning text associated with the soundtrack segment.

5. The method of claim 2, wherein the text includes speech recognition text derived from the soundtrack segment.

6. The method of claim 1, further comprising providing the custom video presentation to a display device.

7. The method of claim 1, further comprising receiving an ordering specification, wherein the relevant segments are concatenated according to the ordering specification.

8. The method of claim 7, wherein the ordering specification further comprises a criteria weighting, a program weighting, a program recording date, a user specified order, a frequency of matches to a content criterion or any combination thereof.

9. The method of claim 1, further comprising:
receiving data identifying at least one entire video program to be included in the custom video presentation;
storing the at least one entire video program; and
wherein the custom video presentation includes the at least one entire video program.

10. The method of claim 1, further comprising:
sending the content criteria from the set-top box device to at least one peer device via a peer-to-peer network; and
receiving one or more relevant segments from the at least one peer device, wherein the custom video presentation includes the received relevant segments.

11. The method of claim 10, further comprising receiving, from the peer-to-peer network, associated program data for each relevant segment, the associated program data comprising a video program airing date and a video program generation date.

12. The method of claim 1, further comprising deleting stored program segments that are not relevant segments.

13. The method of claim 1, further comprising entering a segment memory starting address of each relevant segment and a segment duration of each relevant segment to a custom video presentation segment list.

14. A set-top box device, comprising:
a processor and a memory device accessible to the processor, wherein the memory device includes instructions executable by the processor to:
receive data indicating content criteria;
receive data corresponding to one or more selections of video programs, wherein each video program includes at least one program segment having a soundtrack portion;
receive and store the program segments;
determine whether each program segment is a relevant segment based on the content criteria; and
assemble all relevant segments to produce a custom video presentation.

15. The set-top box device of claim 14, wherein the memory device includes instructions executable by the processor to receive data indicating an ordering specification.

16. The set-top box device of claim 15, wherein the memory device includes instructions executable by the processor to assemble the relevant segments according to the ordering specification.

17. The set-top box device of claim 16, wherein the ordering specification includes instructions to order the relevant segments according to a frequency of matches with the content criteria.

18. The set-top box device of claim 16, wherein the ordering specification includes instructions to order the relevant segments according to a criteria weighting.

19. The set-top box device of claim 16, wherein the ordering specification includes instructions to order the relevant segments according to a video program weighting.

20. The set-top box device of claim 16, wherein the user selected ordering instructions comprises instructions to order the relevant segments according to a date and time of broadcast.

21. The set-top box device of claim 14, wherein the memory device includes instructions executable by the processor to identify a start point and a duration of each program segment.

22. The set-top box device of claim 14, wherein the memory device includes instructions executable by the processor to output one or more graphical user interfaces to receive data corresponding to the content criteria, the selections of video programs, an ordering specification, or any combination thereof.

23. The set-top box device of claim 14, further comprising a speech-to-text module to output text data based on a soundtrack portion of a program segment.

24. A processor-readable medium tangibly embodying processor readable instructions executable by a processor to:
receive data indicating content criteria;
receive data corresponding to one or more selections of video programs, wherein each video program includes at least one program segment having a soundtrack portion;
receive and store the program segments;
determine whether each program segment is a relevant segment based on the content criteria; and
assemble all relevant segments to produce a custom video presentation.

25. The processor-readable medium of claim 24, further comprising instructions executable by the processor to search text associated with each soundtrack portion, closed-captioning data associated with the soundtrack segment, or any combination thereof, to identify content related to the criteria.
